(19) United States
(12) Patent Application Publication
(10) Pub. No.: US 2020/0133352 A1
(43) Pub. Date: Apr. 30, 2020

(54) Computer mainframe box which is convenient for heat dissipation

(71) Applicant: Yudong Zhu, Wuhan City (CN)

(72) Inventor: Yudong Zhu, Wuhan City (CN)

(21) Appl. No.: 16/727,873

(22) Filed: Dec. 26, 2019

(30) Foreign Application Priority Data
Apr. 28, 2019 (CN) 2019103482884

(51) Int. Cl. G06F 1/18; G06F 1/20

(52) U.S. Cl. CPC G06F 1/182; G06F 1/20

(57) ABSTRACT

The invention discloses a computer mainframe box which is convenient for heat dissipation, comprising a computer case and a blocking cavity which communicates with the internal cavity of the computer case and has an opening forward. The left end wall of the internal cavity of the computer case is provided with nine rows which communicate with the external space. Air holes, three spring chambers are arranged in the right end wall of the blocking cavity, and a transmission chamber is arranged in the right end wall of the spring cavity. In the work of the present invention, the size of the heat dissipation outlet is adjusted according to the heat dissipation requirements of the computer main box, and the inlet is adjusted. The air inlet condition of the air outlet improves the heat dissipation speed, and the computer main box can be opened directly by simple operation, which is convenient for cleaning the inside of the computer main box.

### CROSS-REFERENCES TO RELATED APPLICATIONS

The present application claims priority from Chinese application No. 2019103482884 filed on Apr. 28, 2019 which is hereby incorporated by reference in its entirety.

### FIELD OF TECHNOLOGY

The invention relates to the field of computer items, and in particular relates to a computer mainframe box which is convenient for heat dissipation.

### TECHNICAL FIELD

At present, the heat dissipation of the computer mainframe at this stage cannot be adjusted very well, and most of them are directly combined with the fans and local ventilation holes to dissipate heat. When the computer mainframe needs a lot of rapid heat dissipation, it cannot meet the requirements well, which affects the computer operation, and When the computer main box needs to be cleaned, it is often necessary to disassemble the main box directly, thereby increasing the workload.

### CONTENT OF THE INVENTION

An object of the present invention is to provide a computer mainframe box that is easy to dissipate heat, so as to solve the problems raised in the background art described above.

In order to achieve the above object, the present invention provides the following technical solution: a computer mainframe box for facilitating heat dissipation, comprising a computer case and a blocking cavity communicating with the internal cavity of the computer case and opening forward, and a left end wall of the internal cavity of the computer case is provided There are nine exhaust holes communicating with the outside space. Three spring chambers are provided in the right end wall of the blocking cavity, a transmission chamber is provided in the right end wall of the spring chamber, and a transmission mechanism is provided in the transmission chamber. The mechanism includes a motor and a transmission shaft that is power-connected to the motor. The transmission shaft is fixed with a transmission reel, the transmission reel is wound with a rope, and the right end wall of the transmission cavity is provided with a spring slot opening to the right. A telescopic spring is fixed on the left end wall of the spring groove, and a winding block is fixed on the right end of the telescopic spring. The winding block is provided with a limiting slot with an opening upward, and a limiting spring is fixed on the lower end wall of the limiting slot. The upper end of the limit spring is fixed with a limit block whose upper end is located in the spring groove. The right end wall of the blocking cavity is also provided with two moving chambers that open to the left, and the right end wall of the spring chamber and the right end of the moving chamber. Wall average A compression spring is fixed, and a spring plate connected to the compression spring is slidably connected in the spring cavity. A blocking plate at the left end of the spring plate is located in the blocking cavity and partitions the blocking cavity. A moving plate having a right end connected to the compression spring and separating the blocking cavity at a left end is fixed in the moving cavity, and a right end of the spring plate is fixed with a locking chain whose right end is located in the transmission cavity and can pull the spring plate, The right end of the moving plate is provided with a string having a right end located in the transmission cavity and capable of pulling the moving plate. A filter mechanism is provided in the lower end wall of the transmission cavity, and the filter mechanism includes an air inlet to the transmission cavity. An air inlet, a right end wall of the air inlet is provided with a translation cavity opening to the right, a perforated plate and a filter are arranged in the air inlet, and a transversal cavity is provided in the translation cavity, which can drive the perforated plate and the A translation plate for the filter screen movement, a pull ring is provided at the right end of the translation plate, and its function is to adjust the movement of the three blocking plates according to the heat dissipation needs.

Preferably, the transmission mechanism further includes three transmission plates, the transmission plate is provided with a through hole penetrating through the transmission plate, and a support rod penetrating through the through hole is fixed between the left and right end walls of the transmission cavity. A friction rod penetrating through the through hole is slidably connected to the support rod, the rope passes through the spring slot and is connected to the right end of the friction rod after winding the winding block, and the right end of the friction rod is provided with a right end A transmission spring connected to the right end wall of the transmission cavity, the right side of the three chains are connected to three transmission plates, the right end of the string is connected to the left transmission plate, and two friction rods are provided on the friction rod. There are friction cones of different sizes on the right side. The upper and lower end walls of the two through holes on the right side are provided with friction grooves that communicate with the through holes. One end wall of the friction groove is provided with a limiting spring. One end of the restricting spring is provided with a small block with one end in the through hole, one end of the restricting spring is provided with a large block with one end in the through hole, and a fixing block is provided at the lower end wall of the transmission cavity. Controlling the blocking plate move.

Preferably, the filtering mechanism further includes a restriction slot opening to the right, a left end wall of the restriction slot is provided with a tension spring, a right end of the tension spring is provided with a pull rod, and an upper end of the right end of the pull rod is provided at the upper end. In the translation block in the translation cavity, the left end wall of the air inlet is provided with a driven cavity that opens to the right and communicates with the transmission cavity. The driven cavity is provided with an upper end connected to the lower end of the left transmission plate. A driven rod, a driven plate is provided at the lower end of the driven rod, and an electromagnet is provided at the right end of the driven plate, and its role is to directly penetrate the air inlet when the transmission plate on the left moves.

In summary, the beneficial effects of the present invention are: the device has a simple structure and is easy to operate. According to the heat dissipation requirements of the computer main box, the size of the heat dissipation outlet is adjusted, the air inlet condition of the air inlet is adjusted, and the heat dissipation speed is improved. The computer main box can be opened directly, which is convenient for cleaning the inside of the computer main box.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely Some embodiments of the invention can be obtained by those skilled in the art based on these drawings without paying any creative effort. The invention will be described in detail below with reference to FIGS. 1-2. For the convenience of description, the following orientations are defined as follows: the up-down, left-right, and front-back directions described below are consistent with the up-down, left-right, and front-back directions of the projection relationship of FIG. 1 itself.

FIG. 1 is a schematic front structural view of a whole cross-section of a computer main box that facilitates heat dissipation according to the present invention;

FIG. 2 is a partially enlarged front view of the transmission mechanism of a computer main box transmission mechanism for facilitating heat dissipation according to the present invention.

### DETAILED DESCRIPTION OF THE INVENTION

All features disclosed in this specification, or all disclosed methods or steps, other than mutually exclusive features and/or steps, may be combined in any manner.

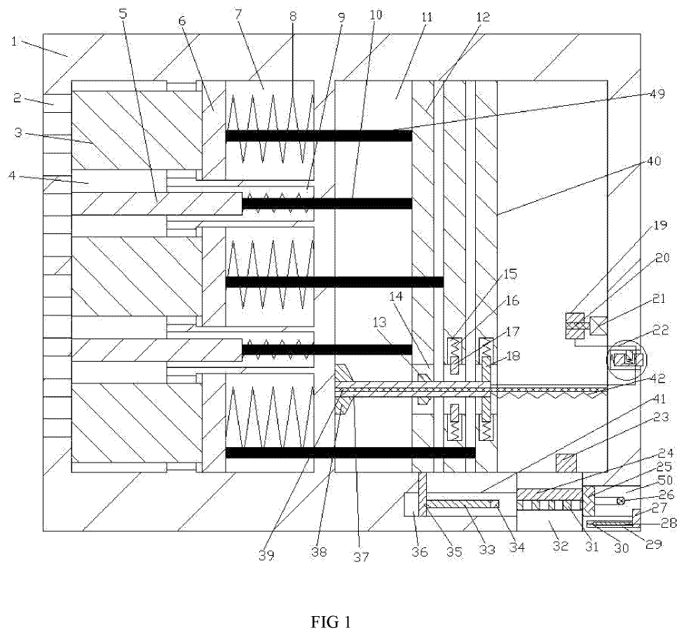

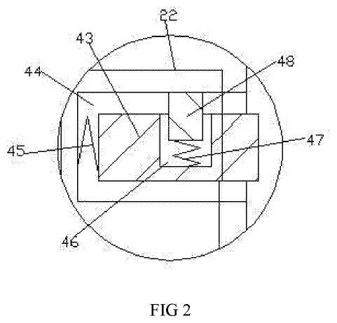

Please refer to FIGS. 1-2. An embodiment of the present invention provides a computer mainframe case for facilitating heat dissipation, including a computer case 1 and a blocking cavity 4 communicating with an inner cavity of the computer case 1 and opening forward. The left end wall of the internal cavity of the computer case 1 is provided with nine exhaust holes 2 that communicate with the external space. The right end wall of the blocking cavity 4 is provided with three spring cavities 7, and the transmission cavity 11 is provided in the right end wall of the spring cavity 7, A transmission mechanism 40 is provided in the transmission chamber 11. The transmission mechanism 40 includes a motor 21 and a transmission shaft 20 that is power-connected to the motor 21. A transmission reel 19 is fixed to the transmission shaft 20. A rope 22 is wound on the wheel 19, and a right-side spring groove 44 is provided on the right end wall of the transmission cavity 11. A telescopic spring 45 is fixed on the left end wall of the spring groove 44 and a winding block 43 is fixed on the right end of the telescopic spring 45. The winding block 43 is provided with a limiting slot 46 with an opening upward, a lower end wall of the limiting slot 46 is fixed with a limit spring 47, and an upper end of the limit spring 47 is fixed with an upper end located in the spring slot 44. Limiting block 48, the right end wall of the blocking cavity 4 is also provided with two moving cavities 9 opening to the left, A compression spring 8 is fixed to both the right end wall of the spring cavity 7 and the right end wall of the moving cavity 9. A spring plate 6 connected to the compression spring 8 is slidably connected to the spring cavity 7. The left end of the spring plate 6 is provided with The left end is located in the occlusion cavity 4 and blocks the occlusion plate 3 separating the occlusion cavity 4. The moving cavity 9 is fixed with a right end connected to the compression spring 8 and the left end separates the movement of the occlusion cavity 4. Plate 5, the right end of the spring plate 6 is fixed with a chain 49 with a right end located in the transmission cavity 11 and capable of pulling the spring plate 6, and a right end of the moving plate 5 is provided with a right end located in the transmission cavity 11 and can be pulled The string 10 of the moving plate 5 is provided with a filtering mechanism 41 in the lower end wall of the transmission cavity 11, and the filtering mechanism 41 includes an air inlet 32 for inhaling air to the transmission cavity 11, and the air inlet 32 The right end wall is provided with a translation cavity 50 which opens to the right. The air inlet 32 is provided with a perforated plate 31 and a filter 24. The translation cavity 50 is provided with a perforated plate 31 and the filter 24. The moving translation plate 25 is provided with a pull ring 26 at the right end of the translation plate 25, and its function is to adjust three blocks according to the heat dissipation requirements. 3 moves.

Beneficially, the transmission mechanism 40 further includes three transmission plates 12. The transmission plates 12 are provided with through holes 14 penetrating the transmission plates 12, and the left and right end walls of the transmission cavity 11 are fixedly provided with the through holes. A support rod 39 of the through-hole 14 is frictionally connected to the support rod 39 through the through-hole 14. The rope 22 passes through the spring groove 44 and is connected with the winding block 43 after being wound around the winding block 43. The right end of the friction rod 37 is connected, and the right end of the friction rod 37 is provided with a transmission spring 42 connected at the right end to the right end wall of the transmission cavity 11, and the right end side of the three chains 19 is connected to three transmission plates 12. The right end of the string 10 is connected to the transmission plate 12 on the left side. The friction rod 37 is provided with two tapered friction blocks 38 of different sizes. The upper and lower end walls of the two right through holes 14 are communicated with each other. The friction groove 15 of the through hole 14 is provided with a limiting spring 16 on one end wall of the friction groove 15, and a small square 17 is located on one end of the limiting spring 16 on the left side of the through hole 14 on the right side. One end of the limiting spring 16 is provided with a large block 17 located in the through hole 14 at one end, and the transmission The lower end wall of the cavity 11 is provided with a fixing block 23 which is used to control the movement of the blocking plate 3.

Beneficially, the filtering mechanism 41 further includes a restriction groove 29 opening to the right, a left end wall of the restriction groove 29 is provided with a tension spring 30, and a right end of the tension spring 30 is provided with a pull rod 28, the pull The right end of the rod 28 is provided with a translation block 27 whose upper end is located in the translation cavity 50. The left end wall of the air inlet 32 is provided with a driven cavity 36 which opens to the right and communicates with the transmission cavity 11. The driven cavity 36 Inside there is a driven rod 35 with an upper end connected to the lower end of the transmission plate 12 on the left side, a driven plate 33 is provided at the lower end of the driven rod 35, and an electromagnet 34 is provided at the right end of the driven plate 33. Its role is to When the transmission plate 12 moves on the left, it directly penetrates the air inlet 32.

In the following, the applicant will refer to the attached drawings 1-2 and the specific composition of a computer mainframe that facilitates heat dissipation in the present application as described above to introduce in detail a method of using a computer mainframe that facilitates heat dissipation in this application:

When it is necessary to increase the heat dissipation, the motor 21 works to drive the transmission shaft 20 and the transmission reel 19 to rotate, thereby tightening the rope 22, moving the friction rod 37 to the right, and moving the large block 18 and the right transmission plate 12 to the right. Move the lower blocking plate 3 and the spring plate 6 to the right. When the right transmission plate 12 is in contact with the fixed block 23, the motor 21 continues to work, and the right conical friction block 13 is in contact with the small block 17, thereby driving the middle transmission plate 12. Move to the right, and so on. When the middle transmission plate 12 is in contact with the right transmission plate 12, the left conical friction block 12 contacts the left transmission plate 12 to drive the left transmission plate 12 to the right, and finally three blocks are blocked. Driven by the transmission plate 12, the plate 3 and the moving plate 5 communicate with the outer space of the front wall of the plugging cavity 4, and the compression spring 8 compresses to increase the air outlet space;

When the left transmission plate 12 moves to the right, the driven rod 35, the driven plate 33, the perforated plate 21, the filter 24, the translation plate 25 and the pull ring 26 are moved to the right, and the limit block 48 is pushed upward to restrict the winding. The block 43 is reset, so that the internal cavity of the computer case 1 directly communicates with the external space through the air inlet, which is convenient for increasing the air intake. When the computer case 1 needs to be cleaned, pull the winding block 43 to the right and manually pull the rope 22 to close the cavity. 4 Open as above to facilitate cleaning of the internal cavity of the computer case 1. Pull the pull ring 26. Under the restriction of the translation block 27 and the pull rod 28, remove and replace the filter 24. After the cleaning is completed, press the limit block 48. Reset under the action of the spring.

The beneficial effects of the present invention are that the device has a simple structure and convenient operation. According to the heat dissipation requirements of the computer main box, the size of the heat dissipation outlet can be adjusted, the air inlet condition of the air inlet can be adjusted, and the heat dissipation speed can be improved. Main box, easy to clean the inside of computer main box.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. A computer mainframe box for facilitating heat dissipation includes a computer case and a blocking cavity which communicates with the internal cavity of the computer case and has an opening forward, characterized in that the left end wall of the internal cavity of the computer case is provided with nine rows that communicate with the external space. air holes, three spring cavities are provided in the right end wall of the plugging cavity, a transmission cavity is provided in the right end wall of the spring cavity, and a transmission mechanism is provided in the transmission cavity. the transmission mechanism includes a motor and a motor. a power-connected transmission shaft is fixed with a transmission reel, the transmission reel is wound with a rope, the right end wall of the transmission cavity is provided with a spring slot opening to the right, and the left end wall of the spring slot is fixed with a telescoping spring, a winding block is fixed at the right end of the telescoping spring, a limiting slot with an upward opening is arranged in the winding block, a limiting spring is fixed at the lower end wall of the limiting slot, and an upper end is fixed at the upper end of the limiting spring a limiting block located in the spring groove, the right end wall of the plugging cavity is further provided with two moving cavities that open to the left, and a compression spring is fixed to the right end wall of the spring cavity and the right end wall of the moving cavity. inside the spring cavity a spring plate connected to the compression spring is slidably connected, and a left end of the spring plate is provided with a plugging plate whose left end is located in the plugging cavity and partitions the plugging cavity, and a right end is fixed in the moving cavity. the compression spring is connected to the left end of the moving plate that separates the blocking cavity. the right end of the spring plate is fixed with a right end located in the transmission cavity and can pull the spring chain. the right end of the moving plate is provided with a right end at the right end. a thin rope in the transmission cavity can be used to pull the moving plate. a filter mechanism is provided in the lower end wall of the transmission cavity. the filter mechanism includes an air inlet to the transmission cavity, and the right end of the air inlet the wall is provided with a translation cavity opening to the right, a perforated plate and a filter are provided in the air inlet, and a translation plate is provided in the translation cavity which can move the perforated plate and the filter, and the translation a pull ring is provided at the right end of the board, and its function is to adjust the movement of the three blocking boards according to the heat dissipation needs.

2. The computer mainframe case according to claim 1, wherein the transmission mechanism further comprises three transmission plates, and the transmission plate is provided with a through hole penetrating through the transmission plate, and the transmission a support rod penetrating the through hole is fixed between the left and right end walls of the cavity. a friction rod penetrating the through hole is slidably connected to the support rod. the rope passes through the spring groove and is wound around the winding block. the rear end is connected with the right end of the friction rod. the right end of the friction rod is provided with a transmission spring connected to the right end wall of the transmission cavity. the right end of the three chains is connected to three transmission plates and the right end of the string. it is connected with the transmission plate on the left side, the friction rod is provided with two tapered friction blocks of different sizes, and friction grooves communicating with the through holes are provided in the upper and lower end walls of the two right through holes. one end wall of the friction groove is provided with a limiting spring, one end of the limiting spring is provided with a small block with one end located in the through hole, and one end of the limiting spring is provided with one end located in the through hole. big square, said pass a fixed block is provided at the lower end wall of the movable cavity, and its function is to control the movement of the blocking plate.

3. The computer mainframe case according to claim 1, wherein the filtering mechanism further comprises a restriction groove opening to the right, and a left end wall of the restriction groove is provided with a tension spring, and the tension spring a right end is provided with a lifting rod, a right end of the lifting rod is provided with a translation block whose upper end is located in the translation cavity, and a left end wall of the air inlet is provided with a driven cavity opening to the right and communicating with the transmission cavity. the driven cavity is provided with a driven rod whose upper end is connected to the lower end of the transmission plate on the left side, a driven plate is provided on the lower end of the driven rod, and an electromagnet is provided on the right end of the driven plate. the transmission plate directly penetrates the air inlet when moving.
